(19) United States
(12) Patent Application Publication
(10) Pub. No.: US 2006/0240276 A1
(43) Pub. Date: Oct. 26, 2006

(54) Underlayer for reducing surface oxidation of plated deposits

(75) Inventors: Robert A. Schetty III, Laurel Hollow, NY (US); Winnie Ruth Vickers, Lynbrook, NY (US)

Correspondence Address: WINSTON & STRAWN LLP, 1700 K STREET, N.W., WASHINGTON, DC, 20006, US

(73) Assignee: Technic, Inc.

(21) Appl. No.: 11/406,261

(22) Filed: Apr. 19, 2006

Related U.S. Application Data
(60) Provisional application No. 60/672,859, filed on Apr. 20, 2005.

(51) Int. Cl. C25D 5/10; B32B 15/01

(52) U.S. Cl. 428/648; 205/170; 428/929

(57) ABSTRACT

Methods of providing improved metal coatings or metal deposits on a substrate, improvements in plating solutions that are used to provide such metal deposits and articles of the metal-coated substrates. The solderability of the metal coating is enhanced by incorporating trace amounts of phosphorus in the metal coating to reduce surface oxide formation during subsequent heating and thus enhance long term solderability of the metal coating. The phosphorus is advantageously provided in the metal coating by incorporating a source of phosphorus in a solution that is used to provide the metal coating on the substrate, and the metal coating is then provided on the substrate from the solution.

### CROSS-REFERENCE TO RELATED APPLICATION

This application claims the benefit of U.S. provisional application No. 60/672,859 filed Apr. 20, 2005. The entire content of that application is expressly incorporated herein by reference thereto.

### BACKGROUND ART

The present invention relates to a process for reducing or minimizing surface oxidation of a metal deposit provided by a plating process such as electroplating. These processes also provide improved plated deposit properties including appearance, solderability and reflow capability.

Electroplated tin and tin alloy coatings have been used in electronics and other applications such as wire, and continued steel strip for many years. In electronics, they have been used as a solderable and corrosion resistive surface finish for contacts and connectors. They are also used a lead finish for integrated circuit (“IC”) fabrication. In addition, a thin layer of tin or tin alloy is applied as the final step for passive components such as capacitors and transistors.

Though applications vary, there are some commonalities regarding the requirements for this final surface finish. One issue is long term solderability, defined as the ability of the surface finish to melt and make a good solder joint to other components without defects that would impair the electrical or mechanical connection.

There are many factors that determine good solderability, the three most important of which are extent of surface oxide formation, amount of codeposited carbon, and extent of intermetallic compound formation. Surface oxide formation is a natural occurring process because it is thermodynamically favorable. The rate of formation of the surface oxide depends on the temperature and time. In another words, the higher the temperature and longer the time, the thicker the surface oxide that is formed. In the case of electroplated tin or tin alloy coatings or deposits, surface oxide formation also depends on the surface morphology of the coating or deposit. When comparing pure tin to tin alloy coatings, for example, tin alloys generally form less or thinner surface oxides when all other conditions are equal.

Codeposited carbon is determined by the plating chemistry one chooses to use. Bright finishes contain higher carbon contents than matte finishes. Matte finishes are normally rougher than the bright finishes, and provide an increased surface area that results in the formation of more surface oxides than typically are formed with a bright finish. The plater thus has a trade off between potential amount of surface oxide and surface finish.

Intermetallic compound formation is a chemical reaction between the tin or tin alloy coating and the substrate. The rate of formation depends on temperature and time as well. Higher temperatures and longer times result in a thicker layer of intermetallic compounds.

To improve or ensure the highest degree of solderability, it is important to 1) use a non-bright tin or tin alloy plating solution, 2) deposit a sufficient layer of tin or tin alloy so that surface oxide or intermetallic compound formation will not consume the entire layer, and 3) to prevent or minimize exposure of the tin plated surface to elevated temperatures for extend periods of time.

It is relatively easy to achieve 1) and 2), but it is very difficult to achieve 3). The temperature and time of subsequent part treatment after plating of a tin or tin alloy deposit is normally dictated by the assembly specifications and existing manufacturing layout and practice. For example, in “two tone” leadframe technology, after the tin or tin alloy plating, the entire package will have to go through many process steps (i.e., a long period of time for such treatments) which require multiple thermal excursions at temperatures as high as 175° C. Inevitably, more and/or thicker surface oxides form, and this in turn reduces the solderability of the tin or tin alloy deposit. In current processing, it is not possible to omit these additional steps since the final components or assemblies will not be complete.

In the leadframe silver plating industry, a postreatment process is generally required to enhance anti-copper peeling properties. A common approach is to form an organometallic protective layer, but this approach suffers from a number of problems:
a high operating cost due to the use of a precious metal as a protective coating;
an unstable process after treatment due to silver-copper migration;
deterioration of the protective layer during storage;
performance is dependent upon the quality of the copper strike deposits; and
potential for whisker formation if silver coating is too thick.

Therefore it is highly desirable to find ways to prevent or minimize surface oxide formation on such parts. One known way to do this is to introduce a conformal coating on the surface of the tin or tin alloy deposit. This technology can be summarized in two general categories: one that applies a precious metal coating and the other that applies an organic coating. The first category is undesirable for protection of tin or tin alloy deposits because it introduces an expensive, extra process step. The second category is also undesirable because it will inevitably introduce impurities onto other critical areas of the leadframe or electrical component due to the non-selective nature of the organic coating that is deposited. These impurities have proven to be detrimental to the subsequent leadframe and IC assembly processes.

For other applications, the metal deposit, often tin in the form of tinplate, is subject to a reflow operation where the deposit is melted and caused to flow over the substrate surface. Minimizing surface oxidation of such deposits greatly facilitates the uniformity and final appearance of the reflowed deposit and methods for accomplishing this are therefore needed.

Accordingly, the present invention now provides such methods.

### SUMMARY OF THE INVENTION

The invention generally relates to methods of providing plated metal deposits having improved surface properties and appearance.

The invention relates to a method for enhancing solderability or reflow properties of a metal deposit that is plated upon a substrate by providing an intermediate metal layer between the plated metal deposit and the substrate. The intermediate layer preferably includes phosphorus in an amount sufficient to reduce surface oxide formation of the plated metal deposit during subsequent heating or processing to thus enhance solderability and reflow of the plated metal deposit.

The metal layer generally includes nickel, cobalt, copper, tungsten, zinc, tin or one of their alloys, and the phosphorus is present in the metal layer in a detectable amount but less than about 2% by weight. The phosphorus is generally present in the metal layer as an alloy with the metal.

Advantageously, the phosphorus is provided in the metal layer by incorporating a source of phosphorus in a solution that is used to provide the metal layer on the substrate, and providing the metal layer on the substrate from the solution prior to plating the metal deposit. This may be a compound of phosphorus that is soluble in the solution and which provides the amount of phosphorus in the metal layer. Thus, the metal layer can be provided by electroplating with the source of phosphorus is added to a solution of ions of the metal so that phosphorus can be co-deposited as an alloy of the metal during the electroplating. The phosphorus compound is phosphoric acid, hypophosphoric acid or sodium hypophosphite and the metal layer is preferably produced by electroplating at a current density of no greater than about 2000 ASF.

Another way of adding phosphorus to the intermediate metal layer is by a post treatment of the layer surface with a solution of the phosphorus compound, optionally including an organic acid or salt thereof.

The plated metal deposit also can be nickel, cobalt, copper, tungsten, zinc, tin or one of their alloys. It optionally may include phosphorus but in an amount of up to about 1% by weight. The plated metal deposit may also be produced by electroplating.

The invention also relates to an article that includes a plated metal deposit on an intermediate metal layer upon a substrate wherein the metal layer includes phosphorus therein in an amount sufficient to reduce surface oxide formation of the plated metal deposit during subsequent heating or processing to thus enhance solderability and reflow of the plated metal deposit. A typical intermediate metal layer is a 100 microinch deposit of nickel, and this can be provided on a steel or copper substrate, with a preferred layer thereon that is 150 microinches of tin.

### DETAILED DESCRIPTION OF THE PREFERRED EMBODIMENTS

This invention realizes the importance of incorporating phosphorus or a phosphorus compound in metal or metal alloy layers or deposits. It was surprising to find that the inclusion of this element in an intermediate layer significantly reduces surface oxidation of metal deposits that are plated upon the intermediate layer when those deposits are subjected to heating or other subsequent processing. It is also possible to add phosphorus to the plated metal deposit for further resistance against surface oxidation during such further processing. The reduction of surface oxidation directly contributes to significantly improving long term solderability of such deposits as well as their ability to uniformly reflow when heated. Since phosphorus preferably can be added to the metal layer or plated deposit through the same manufacturing step that is used to deposit the metal, it does not require additional processing steps nor does it introduce impurities onto the entire package.

The amount of phosphorus in the intermediate layer can range from trace amounts, usually measured in ppm, up to about 2% by weight. A similar amount can be used for the plated metal deposit except that the upper limit is around 1% by weight. The term “trace amounts” is used to mean a detectable amount of an element such as phosphorus that is present in a metal deposit and which amount provides a measurable improvement in the long term solderability of the metal deposit. The term “ppm levels” stands for the amount in parts per million range of an element such as phosphorus that is present in a metal deposit to provide a measurable improvement in the long term solderability of the metal deposit.

The preferred amounts can vary widely depending upon the specific metal deposit. For example, in an intermediate layer comprising nickel, the amount will be on the order of 1 to 1.5% by weight or less while for tin and tin alloys it will be on the order of 200 to 500 ppm to as high as 1%.

This additive can be used for any plated deposit that is to be soldered. This includes, among others, tin, nickel, copper, cobalt, tungsten, zinc, or one of their alloys. Soldering is basically an attachment procedure that usually involves three materials: (1) the substrate; (2) the component or other device which is desired to be attached to the substrate; and (3) the soldering material itself. The soldering material itself usually is a tin or tin alloy, but the substrate or component/device can be made of other metals. In the present invention, phosphorous is added to the metal deposit to improve the solderability properties of substrates that contain such deposits and/or the components/devices to be attached to them.

The substrate or component/device material comprises an electroplatable material such as copper, steel, or stainless steel. The invention reduces the surface oxidation of the substrate and/or device which improves its ability to be soldered with the soldering material. It can also reduce the formation of intermetallic compounds for his purpose. Tin and tin alloy deposits are preferred as metal deposits since they act as solders on their own or can be subjected to reflow when heated above their relatively low melting temperatures. However, the reductions in surface oxidation is useful for the other metals recited since it is easier for solders to adhere to those metals due to reduced interference from oxidized surfaces. For example, when phosphorus is present in a nickel or copper deposit, it may eliminate the need for a further coating of tin, a tin alloy or a precious metal.

Tin and tin alloys are known to have various plating chemistries that can produce various characteristics in the resulting plated deposits. These include appearances of matte, bright and others (e.g., satin bright). These can be achieved by a number of known chemistries based on sulfonates, mixed acids, sulfates, halogens, fluoborates, gluconates, citrates and the like. For environmental reasons, sulfonic acids, such as alkyl or alkylol sulfonic acids (e.g., methane sulfonic acid), are preferred. In addition, the skilled artisan would know that these baths may contain various additives to facilitate or enhance plating performance. Examples of preferred chemistries include U.S. Pat. Nos. 6,251,253; 6,248,228; 6,183,619; and 6,179,985; the content of each of which is expressly incorporated herein by reference thereto. These patents also disclose plating solutions and processes for other metals besides tin.

According to the invention, the plating solution can be modified with the addition of a small amount of a source of phosphorus. The phosphorus source can be an organic or inorganic phosphorus compound that is at least partially and preferably highly or fully soluble in the plating solution. Various alkali or alkaline earth phosphites or phosphates can be used, with hypophosphites being preferred. Hypophosphorous or hypophosphoric acid as well as pyrophosphides can be used, if desired. Phosphoric acid can be used if desired, either as an additive to the electroplating solution, or as a post treatment of the surface to assist in the prevention of surface oxidation. These compounds can be used in a wide rage of concentrations, and the skilled artisan can conduct routine tests to determine the optimum concentration for any particular bath formulation. It has been found that between 5 to 200 μl and preferably from about 1 to 150 g/l of phosphorus compound are suitable for most conventional baths. When the phosphorus compound is a liquid, concentrations of between 20 and 60 ml/l can be used. A preferred additive is sodium hypophosphite which can be added at an amount of between 10 and 175 g/l to the base electroplating bath. An alternate preferred additive is hypophosphoric acid used in an amount of between 20 and 60 ml/l.

It has been found that phosphorus can be deposited over a wide range of electroplating conditions depending upon the specific metal to be plated. Generally, current densities of less than about 2000ASF are used. Depending upon the specific plating equipment, current densities of less than 1000 ASF, less than 500ASF or even between 25 and 150ASF can be used. With higher current densities, metal deposits are made more quickly so that lower amounts of phosphorus found in the deposit. The bath formulator should add a sufficient amount of the phosphorus source so that the amount of phosphorus in the deposit is detectable. One way to do this is to increase the amount of phosphorus source in the bath, but this is not preferred since it can affect bath stability of other performance criteria. Instead, it is much easier to control the current density to the desirable ranges mentioned above since small amounts of the phosphorus source can be used without affecting or significantly impacting overall bath chemistry.

It has also been found that a post treatment after conventional metal deposition can be used to reduce surface oxidation. A preferred treatment is a solution that includes a phosphorus compound such as phosphoric acid, hypophosphoric acid or sodium hypophosphite. The concentration of these compounds can range from 20 to 60 g/l. Optionally, a complexing agent of an organic acid or organic acid salt can be included in an amount of between 10 and 100 g/l. Sodium gluconate at a concentration of 50 g/l is suitable for this purpose. Other suitable organic acids or salts thereof include citric or oxalic acids or their alkali metal salts.

A typical nickel plating solution according to the invention and its typical electroplating conditions are as follows:

Nickel as nickel sulfamate 110 to 130 g/l

Nickel bromide 15 to 25 ml/l

Boric acid 22 to 30 g/l

Phosphorus additive 20 to 60 ml/l

Wetting agent 1.5 to 3 ml/l

Brightener (optional) 1 to 5 ml/l

pH 2 to 4.5

Current density 4 to 40 ASD

Temperature 50-60° C.

Anodes: nickel “S” rounds

An anode:cathode ratio of approximately 1:1 is used.

Of course, the skilled artisan can select other metal salts or particular wetting agents or brighteners as desired based on known chemistries. Also, if necessary, routine testing can be conducted to optimize any particular bath formulations.

The substrates to be plated can vary over a wide range. Of course, the usual metal substrates, such as copper steel or stainless steel are typically used, but the invention is also operable on composite substrates that include conductive and non-conductive or electroplatable and non-electroplatable portions. This provides the plater with a number of options for manufacturing may different types of parts or articles with the phosphorus containing deposits of the invention.

The resulting plated products can be used in a number of different applications in the fields of electronics, wire coating, steel plating, tinplate and others where enhanced solderability of reflow properties are needed. It has been found that incorporating phosphorus in the deposit helps to significantly reduce surface oxidation in deposits that have matte or bright finishes. As noted, this results in improved solderability performance.

Further unexpected benefits were discovered in connection with reflow processing of plated metal deposits, and in particular with tin deposits or tinplate. The reduction of surface oxidation enables a more uniform better appearing reflow deposit to be easily achieved.

As noted, the invention is utilizable for depositing different base metals with excellent results in reduction of surface oxidation during routine processing of the electroplated parts. For example, the addition of phosphorus or a phosphorus compound in a nickel electroplating solution for depositing a nickel metal underlayer for a tin deposit provides various improvements in the reduction of tin oxidation when the plated parts are subjected to reflow heating or other elevated temperatures. No discoloration or oxide formation was noted in such tests, whereas nickel underlayers that did not include phosphorus could not prevent discoloration during such additional processing. Additional advantages include lower consumption of additive, better bath stability, no exhibiting of a black nickel deposit after solution aging, and improved deposit surface morphology.

For other deposits, such as copper for example, when leadframes are to be subjected to thermal aging, the present invention provides a simple approach to avoid copper aging, namely the addition of the phosphorus additive to the copper strike bath to minimize the formation of surface copper oxides. This performance can be further enhanced by the addition of an organic protective layer, if desired. At the same time, this treatment avoids the problem of epoxy bleed out without affecting the functional properties of the leadframe.

The metal deposits that include underlayers according to the invention can be subjected to soldering with improved results. Also, such layers can be subjected to reflow with less difficulties. A typical test for reflow includes the following conditions:

Heat the deposit at 260° C. in an infrared radiation oven

Hold the heated deposit for 20-40 seconds above that temperature

Pass the plated parts three times through the oven

Air atmosphere present in oven: no flux applied.

Also, the typical salt spray test is known as ASTM B-117. The conditions for this test include:

A temperature of 35° C.

Application of a 5% NaCl solution at a pH of 6.5 sprayed on the sample at rate of 1.6 ml/hr for a selected time period of 24 or 48 hours.

To illustrate the benefits of the present invention, a bright tin deposit over a nickel underlayer that includes phosphorus exhibits no discoloration after 48 hours in this salt spray test.

The phosphorus content of the metal layer can be determined by a wet method where the deposit is dissolved in nitric acid and ICP detection techniques are used to measure phosphorus content.

Measures of solderability can be determined using the Dip and Look, Wetting Balance and Surface Mount Solderability Test method per IPC/JEDEC Industry Standard J-STD-002A.

What is claimed is:

1. A method for enhancing solderability or reflow properties of a metal deposit that is plated upon a substrate, which comprises providing an intermediate metal layer between the plated metal deposit and the substrate wherein the layer includes phosphorus in an amount sufficient to reduce surface oxide formation of the plated metal deposit during subsequent heating or processing to thus enhance solderability and reflow of the plated metal deposit.

2. The method of claim 1, wherein the metal layer comprises nickel, cobalt, copper, tungsten, zinc, tin or one of their alloys.

3. The method of claim 1, wherein the phosphorus is present in the metal layer in a detectable amount but less than about 2% by weight.

4. The method of claim 3, wherein the phosphorus is present in the metal layer as an alloy with the metal.

5. The method of claim 3, wherein the phosphorus is provided in the metal layer by incorporating a source of phosphorus in a solution that is used to provide the metal layer on the substrate, and providing the metal layer on the substrate from the solution prior to plating the metal deposit.

6. The method of claim 5, wherein the source of phosphorus is a compound of phosphorus that is soluble in the solution and which provides the amount of phosphorus in the metal layer.

7. The method of claim 5, wherein the metal layer is provided by electroplating and the source of phosphorus is added to a solution of ions of the metal so that phosphorus can be co-deposited as an alloy of the metal during the electroplating.

8. The method of claim 7, wherein the phosphorus compound is phosphoric acid, hypophosphoric acid or sodium hypophosphite and the metal layer is produced by electroplating at a current density of no greater than about 2000 ASF.

9. The method of claim 1, wherein the plated metal deposit comprises nickel, cobalt, copper, tungsten, zinc, tin or one of their alloys.

10. The method of claim 9, wherein phosphorus is present in the plated metal deposit layer in a detectable amount up to about 1% by weight.

11. The method of claim 10, wherein the phosphorus is present as an alloy with the metal of the plated metal deposit.

12. The method of claim 10, wherein the phosphorus is provided in the plated metal deposit by incorporating a source of phosphorus in a solution that is used to provide the metal layer on the substrate, and providing the metal layer on the substrate from the solution prior to plating the metal deposit.

13. The method of claim 12, wherein the source of phosphorus is a compound of phosphorus that is soluble in the solution and which provides the amount of phosphorus in the plated metal deposit.

14. The method of claim 12, wherein the plated metal deposit is provided by electroplating and the source of phosphorus is added to a solution of ions of the metal so that phosphorus can be co-deposited as an alloy of the metal during the electroplating.

15. The method of claim 14, wherein the phosphorus compound is phosphoric acid, hypophosphoric acid or sodium hypophosphite and the plated metal deposit layer is produced by electroplating at a current density of no greater than about 2000 ASF.

16. The method of claim 1, wherein the metal layer comprises nickel and the plated metal deposit comprises tin.

17. The method of claim 1 wherein the phosphorus is added to the intermediate metal layer by a post treatment of the layer surface with a solution of the phosphorus compound, optionally including an organic acid or salt thereof.

18. An article comprising a plated metal deposit on an intermediate metal layer upon a substrate wherein the intermediate metal layer includes phosphorus therein in an amount sufficient to reduce surface oxide formation of the plated metal deposit during subsequent heating or processing to thus enhance solderability and reflow of the plated metal deposit.

19. The article of claim 18, wherein the substrate comprises metal, the metal layer comprises nickel, cobalt, copper, tungsten, zinc, tin or one of their alloys in combination with phosphorus in an amount of up to 2 weight percent, and the plated metal deposit comprises nickel, cobalt, copper, tungsten, zinc, tin or one of their alloys.

20. The article of claim 19, wherein the intermediate metal layer comprises nickel and the plated metal deposit comprises tin.
